(19) United States
(12) Patent Application Publication
(10) Pub. No.: US 2014/0316828 A1
(43) Pub. Date: Oct. 23, 2014

(54) SYSTEM AND METHOD FOR EXCHANGING AN ELECTRONIC TICKET

(71) Applicant: FIH (Hong Kong) Limited, Kowloon (HK)

(72) Inventor: Kai-Yu Lin, New Taipei (TW)

(73) Assignee: FIH (Hong Kong) Limited, Kowloon (HK)

(21) Appl. No.: 14/258,135

(22) Filed: Apr. 22, 2014

(30) Foreign Application Priority Data
Apr. 23, 2013 (TW) 102114488

(51) Int. Cl. G06Q 10/02; G06Q 20/12

(52) U.S. Cl. CPC G06Q 10/02; G06Q 20/12
USPC 705/5

(57) ABSTRACT

A computing device exchanges electronic tickets between a first client device and a second client device. The computing device notifies the first client device and the second client device to confirm match success information when first ticket information of the first client device matches second ticket information of the second client device, and second ticket information of the first client device matches first ticket information of the second client device.

### FIELD

Embodiments of the present disclosure relate to data management technology, and particularly to a computing device and method for exchanging an electronic ticket.

### BACKGROUND

It is convenient for a user to buy one or more electronic tickets online with the development of e-commence using an electronic device (for example, a mobile phone). However, it is complicated to change the original electronic ticket for another electronic ticket when the user cannot use the original electronic ticket on time. Additionally, the seller may charge a commission (for example, five percent of the total price of the original electronic ticket).

### BRIEF DESCRIPTION OF THE DRAWINGS

FIG. 1 is a schematic block diagram of one embodiment of an electronic ticket exchange system.

FIG. 2 is a schematic block diagram of one embodiment of the electronic ticket exchange system in FIG. 1.

FIG. 3 is a flowchart illustrating one embodiment of a electronic ticket exchange method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

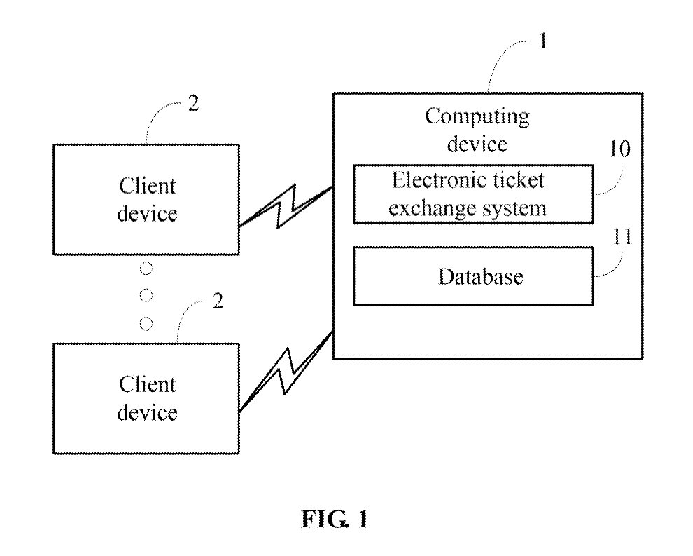

FIG. 1 is a block diagram of one embodiment of a computing device 1 including a electronic ticket exchange system 10. The computing device 1 is wirelessly connected to a plurality of client devices 2 via a network, (for example, the Internet or a local area network. The computing device 1 can be, but is not limited to, a computer, a server, a portable client device, or any other electronic device. The client devices 2 can be, but are not limited to, mobile phones, tablet computers, personal digital assistants (PDAs), or any other portable client devices.

The electronic ticket exchange system 10 provides an operation interface for each client device 2 to execute one or more operations of the computing device 1. For example, the user inputs a username and a password on the operation interface displayed on the client device 2 and logins in the electronic ticket exchange system 10 of the computing device 1. The electronic ticket exchange system 10 is used to exchange electronic tickets between a plurality of client devices 2.

The user also can input first ticket information and second ticket information in the operation interface, and the first ticket information and second ticket information is transmitted to the electronic ticket exchange system 10. The computing device 1 includes a database 11, the database 11 includes a first list and a second list, the first list includes first ticket information of each client device 2, the second list includes second ticket information of each client device 2. The first ticket information includes purchase information, for example, a name, a date, a seat number, a quantity, a type, and a price, of purchase electronic tickets. The second ticket information includes sale information, for example, a name, a date, a seat number, a quantity, a type, and a price, of electronic tickets to be sold.

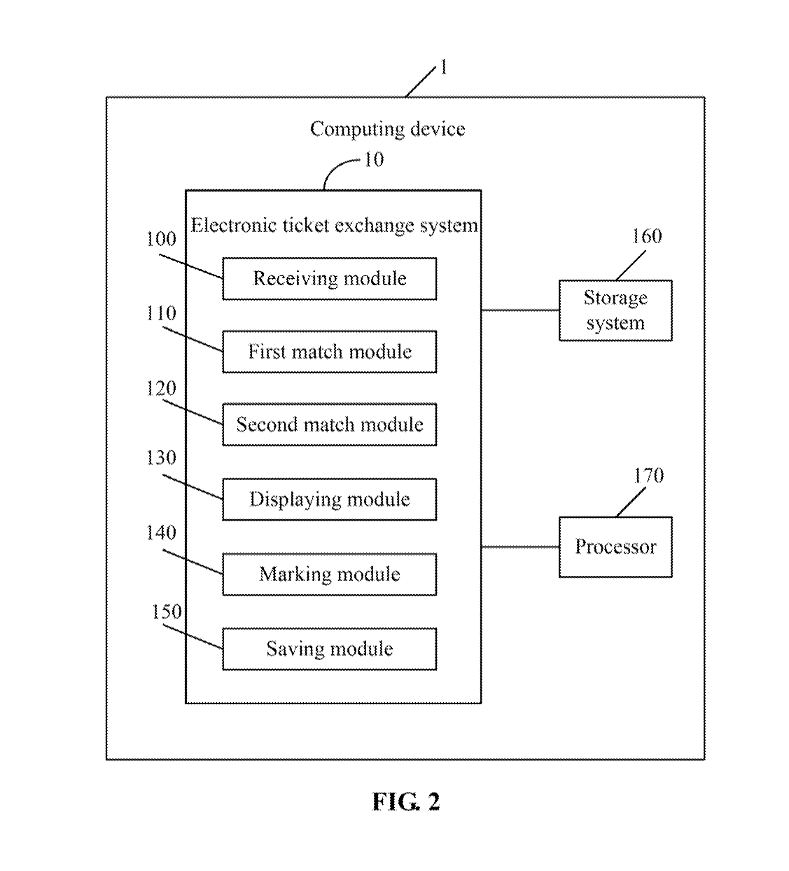

The electronic tickets can be, but are not limited to, movie electronic tickets, railway electronic tickets, or any other electronic tickets. Referring to FIG. 2, an example embodiment, the database 11 can be included in a storage system 160 of the computing device 1.

FIG. 2 is a block diagram of one embodiment of the electronic ticket exchange system 10. In one embodiment, the electronic ticket exchange system 10 includes a receiving module 100, a first match module 110, a second match module 120, a displaying module 130, a marking module, and a saving module 150. The modules 100-150 may include computerized code in the form of one or more programs that are stored in a storage system 160 of the computing device 1. The computerized code includes instructions that are executed by the at least one processor 170 of the computing device 1 to provide functions for modules 100-150. The storage system 160 can be a memory chip, a hard disk drive, or a flash memory stick. Additionally, the storage system 160 also can store the first list and the second list.

The receiving module 100 receives the first and second ticket information from a first client device. In one embodiment, the first client device is one of the client devices 2 wirelessly connected to the computing device 10.

The first match module 110 searches the first list for the first ticket information that matches the second information of the first client device. In one embodiment, the first match module 110 searches the first list for the first ticket information in sequence, for example, a sequence of a storage time of each first ticket information in the first list. In an example embodiment, the first ticket information corresponding to the latest storage time is acquired from the first list to compare with the second information of the first client device. Furthermore, the first match module 110 determines a client device 2 corresponding to found first ticket information to be the second client device, upon the condition that first ticket information that matches the second information of the first client device has been found in the first list. The first match module 110 searches for an identifier (ID) of a second client device according to the found first ticket information. The second client device is one of the client devices 2 wirelessly connected to the computing device 1. The second client device is one of the client devices 2 wirelessly connected to the computing device 1. Additionally, if the found first ticket information corresponds to two or more second client devices, the first match module 110 searches an ID of each of the two or more second client devices 2 according to the first ticket information.

The second match module 120 searches the second list for the second ticket information of the second client device and determines whether the second ticket information of the second client device matches the first ticket information of the first client device. In one embodiment, the second match module 120 searches the second list for the second ticket information of the second client device according to the ID of the second client device.

The displaying module 130 sends match success information to the first client device and the second client device and notifies the first client device and the second client device to confirm the match success information, upon the condition that the second ticket information of the second client device matches the first ticket information of the first client device. The match success information includes a notification message, for example, “match success”, and contact information, for example, a telephone number or an e-mail address, of the first client device and the second client device.

If the match success information is confirmed by the first client device and the second client device, it is indicated that both users of the first client device and the second client device agree to exchange electronic ticket(s). In one embodiment, the match success information is displayed in middle of a screen of the first client device and second client device. The match success information can be, but is not limited to be, integrated into a universal resource locator (URL). The user of the first client device (or the user of the second client device) can confirm the match success information by clicking the match success information displayed on the screen of the first client device (or the second client device) using a finger or a stylus. The user of the first client device (or the user of the second client device) can also confirm the match success information by sending a feedback message, for example, “Agree” or “OK”, to the computing device 1. Additionally, if the user of the first client device (or the user of the second client device) does not confirm the match success information in a predetermined time duration, for example, 5 minutes, the displaying module 130 sends match failure information to the second client device. The user of the first client device (or the user of the second client device) can also cancel the match success information by sending a feedback message, for example, “Disagree,” “Deny” or “No”, to the computing device 1.

The marking module 140 generates a first mark to the first and second ticket information of the first client device and the first and the second ticket information of the second client device, upon the condition that both the first client device and the second client device have confirmed the match success information.

The first mark of the first client device indicates that the first ticket information of the first client device cannot be used to match the second ticket information of any other client device and the second ticket information of the first client device cannot be used to match the first ticket information of any other client device.

The first mark of the second client device indicates that the first ticket information of the second client device cannot be used to match the second ticket information of any other client device and the second ticket information of the second client device also cannot match the first ticket information of any other client device.

The marking module 140 further generates a second mark to the first and second ticket information of the first client device and the first and the second ticket information of the second client device, upon the condition that either of the first client device and the second client device has canceled the match success information. The second mark indicates that the first ticket information of the first client device cannot be used to match the second ticket information of the second client device, and the second ticket information of the first client device cannot be used to match the first ticket information of the second client device.

The saving module 150 saves the first ticket information of the first client device into the first list of the database 11. The saving module 150 can further the second ticket information of the first client device into the second list of the database 11 and generates an ID for the first client device, upon the condition that the no first ticket information in the first list matches the second information of the first client device.

The saving module 150 further saves the first ticket information of the first client device into the first list of the database 11 and the second ticket information of the first client device into the second list of the database 11 and generates the ID for the first client device, upon the condition that the second mark is made to the first and second ticket information of the first client device.

The saving module 150 saves the first ticket information of the first client device into the first list of the database 11 and the second ticket information of the first client device into the second list of the database 11, and generates the ID for the first client device, upon the condition that the second ticket information of the second client device does not match the first ticket information of the first client device.

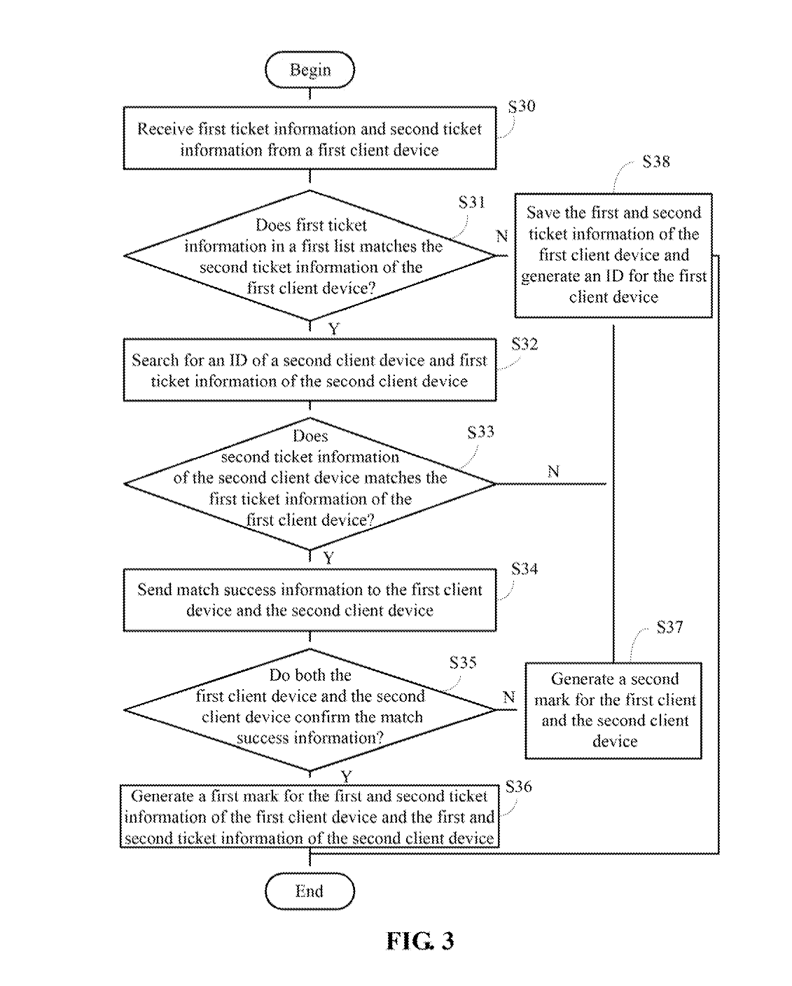

FIG. 3 is a flowchart of one embodiment of a electronic ticket exchange method. Depending on the embodiment, additional steps can be added, others deleted, and the ordering of the steps can be changed.

In step S30, the receiving module 100 receives the first and second ticket information from the first client device. In one embodiment, the first and second ticket information is inputted by the user on an operation interface of the first client device, and is sent to the computing device 1.

In step S31, the first match module 110 searches the first list for first ticket information that matches the second information of the first client device. In one embodiment, the first match module 110 searches the first list for the first ticket information in sequence (for example, the sequence of a storage time of the first ticket information in the first list). If the first list includes the first ticket information that matches the second information of the first client device, the first match module 110 determines a client device 2 corresponding to found first ticket information to be the second client device, the procedure goes to step S32. Otherwise, if the first list does not include the first ticket information that matches the second information of the first client device, the procedure goes to step S38.

In step S32, the first match module 110 searches for an ID of a second client device according to found first ticket information when the first list includes the found first ticket information that matches the second information of the first client device. As mentioned above, the second client device is one of the client devices 2 wirelessly connected to the computing device 1. Additionally, if the first ticket information corresponds to two or more second client devices, the first match module 110 searches for an ID of each second client device according to the first ticket information. The ID can be, but is not limited to, a name of a client device 2, a specific number, a media access control (MAC) address, or a telephone number of the client device 2.

In step S33, the second match module 120 determines whether the second ticket information of the second client device matches the first ticket information of the first client device. In one embodiment, the second match module 120 searches the second list for the second ticket information of the second client device according to the ID of the second client device. If the second ticket information of the second client device in the second list matches the first ticket information of the first client device, the procedure goes to step S34. Otherwise, if the second ticket information of the second client device in the second list does not match the first ticket information of the first client device, the procedure goes to step S38.

In step S34, the displaying module 130 sends match success information to the first client device and the second client device.

In step S35, the displaying module 130 determines whether the match success information is confirmed by the first client device and the second client device. If the match success information is confirmed by the first client device and the second client device, the procedure goes to step S36. Otherwise, if the match success information is not confirmed by the first client device and the second client device (for example, the first client device or the second client device cancel or do not confirm the match success information), the procedure goes to S37.

In step S36, the marking module 140 makes a first mark to the first and second ticket information of the first client device and the first and the second ticket information of the second client device. For example, if the first ticket information of the first client device A matches the second ticket information of the second client device B, and the second ticket information of the first client device A matches the first ticket information of the second client device B, the first mark is made. The first mark indicates that the first ticket information of the first client device A cannot be used to match the second ticket information of any other client device 2, the second ticket information of the first client device A cannot be used to match the first ticket information of any other client device 2. The first mark also indicates that the first ticket information of the second client device B also cannot be used to match the second ticket information of any other client device 2, and the second ticket information of the second client device B also cannot be used to match the first ticket information of any other client device 2.

In step S37, the marking module 140 makes a second mark to the first and second ticket information of the first client device and the first and the second ticket information of the second client device. For example, the second mark indicates that the first and second ticket information of the first client device A cannot be used to match the first and second ticket information of the second client device B. After the second mark is made, the procedure goes to step S38.

In step S38, the saving module 150 saves the first ticket information of the first client device into the first list of the database 11 and the second ticket information of the first client device into the second list, and generates the ID for the first client device.

Although certain inventive embodiments of the present disclosure have been specifically described, the present disclosure is not to be construed as being limited thereto. Various changes or modifications can be made to the present disclosure without departing from the scope and spirit of the present disclosure.

What is claimed is:

1. A computing device in communication with client devices, comprising:
at least one processor; and
a storage system that stores a first list, where the first list comprises a first ticket information of each of the client devices, a second list, where the second list comprises a second ticket information of each of the client devices, and one or more programs, which when executed by the at least one processor, cause the at least one processor to:
receive first ticket information and second ticket information from a first client device; and
transmit match success information to the first client device and a second client device and notify the first client device and the second client device to confirm the match success information, wherein the first ticket information of the first client device matches second ticket information of the second client device in the second list and the second ticket information of the first client device matches first ticket information of the second client device in the first list.

2. The computing device of claim 1, wherein the at least one processor further:
searches the first list for first ticket information that matches the second information of the first client device;
determines a client device corresponding to found first ticket information to be the second client device;
searches for an identifier (ID) of the second client device according to the found first ticket information; and
searches the second list for the second ticket information of the second client device according to the ID of the second client device and determines whether the second ticket information of the second client device matches the first ticket information of the first client device.

3. The computing device of claim 2, wherein the at least one processor further:
stores the first ticket information of the first client device into the first list and the second ticket information of the first client device into the second list and generates an ID for the first client device, wherein the first ticket information does not match the second information of the first client device has been found in the first list.

4. The computing device of claim 2, wherein the at least one processor further:
stores the first ticket information of the first client device into the first list and the second ticket information of the first client device into the second list; generates the ID for the first client device, wherein the second ticket information of the second client device does not match the first ticket information of the first client device.

5. The computing device of claim 1, wherein the at least one processor further:
makes a first mark to the first and second ticket information of the first client device and the first and the second ticket information of the second client device, wherein both of the first client device and the second client device have confirmed the match success information.

6. The computing device of claim 5, wherein the first mark of the first client device indicates that the first ticket information of the first client device cannot be used to match the second ticket information of any other client device and the second ticket information of the first client device cannot be used to match the first ticket information of any other client device, and the first mark of the second client device indicates that the first ticket information of the second client device cannot be used to match the second ticket information of any other client device and the second ticket information of the second client device also cannot match the first ticket information of any other client device.

7. The computing device of claim 1, wherein the at least one processor further:
makes a second mark to the first and second ticket information of the first client device and the first and the second ticket information of the second client device, wherein either of the first client device and the second client device has canceled the match success information.

8. The computing device of claim 7, wherein the at least one processor further:
stores the first ticket information of the first client device into the first list and the second ticket information of the first client device into the second list and generates an ID for the first client device, wherein the second mark is made to the first and second ticket information of the first client device.

9. The computing device of claim 7, wherein the second mark indicates that the first and second ticket information of the first client device cannot be used to match the first and second ticket information of the second client device.

10. The computing device of claim 1, wherein first ticket information comprises purchase information of purchase electronic tickets, and the second ticket information comprises sale information of electronic tickets to be sold.

11. A computer-based electronic ticket exchange method using a computing device in communication with a plurality of client devices, the method comprising:
storing first ticket information of each client device in the first list stored in the computing device;
storing second ticket information of each client device in the second list stored in the computing device;
receiving first ticket information and second ticket information from a first client device; and
transmitting match success information to the first client device and a second client device and notify the first client device and the second client device to confirm the match success information, wherein the first ticket information of the first client device matches second ticket information of the second client device in the second list and the second ticket information of the first client device matches first ticket information of the second client device in the first list.

12. The method of claim 11, wherein the electronic ticket exchange method further comprises:
searching the first list for first ticket information that matches the second information of the first client device;
determining a client device corresponding to found first ticket information to be the second client device;
searching for an identifier (ID) of the second client device according to the found first ticket information; and
searching the second list for the second ticket information of the second client device according to the ID of the second client device and determines whether the second ticket information of the second client device matches the first ticket information of the first client device.

13. The method of claim 12, wherein the electronic ticket exchange method further comprises:
saving the first ticket information of the first client device into the first list and the second ticket information of the first client device into the second list and generating an ID for the first client device, wherein the first ticket information does not match the second information of the first client device has been found in the first list.

14. The method of claim 12, wherein the electronic ticket exchange method further comprises:
saving the first ticket information of the first client device into the first list of the computing device and the second ticket information of the first client device into the second list and generating the ID for the first client device, wherein the second ticket information of the second client device does not match the first ticket information of the first client device.

15. The method of claim 11, wherein the electronic ticket exchange method further comprises:
making a first mark to the first and second ticket information of the first client device and the first and the second ticket information of the second client device, wherein both of the first client device and the second client device have confirmed the match success information.

16. The method of claim 15, wherein the first mark of the first client device indicates that the first ticket information of the first client device cannot be used to match the second ticket information of any other client device and the second ticket information of the first client device cannot be used to match the first ticket information of any other client device, and the first mark of the second client device indicates that the first ticket information of the second client device cannot be used to match the second ticket information of any other client device and the second ticket information of the second client device also cannot match the first ticket information of any other client device.

17. The method of claim 11, wherein the electronic ticket exchange method further comprises:
making a second mark to the first and second ticket information of the first client device and the first and the second ticket information of the second client device, wherein either of the first client device and the second client device has canceled the match success information.

18. The method of claim 17, wherein the electronic ticket exchange method further comprises:
saving the first ticket information of the first client device into the first list and the second ticket information of the first client device into the second list and generating an ID for the first client device, wherein the second mark is made to the first and second ticket information of the first client device.

19. The method of claim 17, wherein the second mark indicates that the first and second ticket information of the first client device cannot be used to match the first and second ticket information of the second client device.

20. The method of claim 11, wherein first ticket information comprises purchase information of purchase electronic tickets, and the second ticket information comprises sale information of electronic tickets to be sold.
